(19) United States
(12) Patent Application Publication
(10) Pub. No.: US 2026/0024063 A1
(43) Pub. Date: Jan. 22, 2026

(54) STORAGE MEDIUM, INFORMATION PROCESSING APPARATUS, AND METHOD OF CONTROLLING THE SAME

(71) Applicant: CANON KABUSHIKI KAISHA, Tokyo (JP)

(72) Inventor: Kazuhiro SUGAWARA, Ibaraki (JP)

(21) Appl. No.: 19/269,232

(22) Filed: Jul. 15, 2025

(30) Foreign Application Priority Data
Jul. 18, 2024 (JP) 2024-114942

(51) Int. Cl. G06Q 20/06; G06Q 20/36

(52) U.S. Cl. CPC G06Q 20/065; G06Q 20/36; G06Q 2220/00

(57) ABSTRACT

The present disclosure is directed to an information processing apparatus that executes a smart contract, the apparatus comprising: in a blockchain network, receiving a transaction related to a token that includes usage information of a service; executing processing requested by the received transaction; determining whether to add a block to a blockchain according to the executed processing; in a case of adding the block, setting a first wallet, which is owned by the information processing apparatus, or a second wallet, which is owned by an issuer of the transaction, as a payer of a fee for adding the block.

### BACKGROUND

### Field of the Technology

The present disclosure relates to a storage medium, an information processing apparatus, and a method of controlling the same.

### Description of the Related Art

Japanese Patent Laid-Open No. 2024-12690 proposes a non-fungible token (NFT) management system that issues an NFT that includes service usage information and grants it to a service user in a service provided to an information processing apparatus owned by the user. In the system, the service usage information is rewritten by the service user.

In the above prior art, there are problems, which will be described below. When using an NFT to rewrite service usage information of a block on a blockchain, a fee for generating a block needs to be paid using a wallet of a service user. That is, the service user has to pay a fee for adding a block each time they rewrite service usage information. Therefore, since the service user has to pay each time they use a service, there is a problem that they end up refraining from using the service.

### SUMMARY

The present technique enables realization of a mechanism for suitable payment of a fee at the time of using a service in a blockchain network.

One aspect of the present disclosure provides a non-transitory computer-readable storage medium storing a computer program that causes a computer of an information processing apparatus that executes a smart contract to function to: in a blockchain network, receive a transaction related to a token that includes usage information of a service; execute processing requested by the received transaction; determine whether to add a block to a blockchain according to the executed processing; in a case of adding the block, set a first wallet, which is owned by the information processing apparatus, or a second wallet, which is owned by an issuer of the transaction, as a payer of a fee for adding the block.

Another aspect of the present disclosure provides an information processing apparatus that executes a smart contract, the information processing apparatus comprising: one or more memory devices that store a set of instructions; and one or more processors that execute the set of instructions to: in a blockchain network, receive a transaction related to a token that includes usage information of a service; execute processing requested by the received transaction; determine whether to add a block to a blockchain according to the executed processing; in a case of adding the block, set a first wallet, which is owned by the information processing apparatus, or a second wallet, which is owned by an issuer of the transaction, as a payer of a fee for adding the block.

Still another aspect of the present disclosure provides a method of controlling an information processing apparatus that executes a smart contract, the method comprising: in a blockchain network, receiving a transaction related to a token that includes usage information of a service; executing processing requested by the received transaction; determining whether to add a block to a blockchain according to the executed processing; in a case of adding the block, setting a first wallet, which is owned by the information processing apparatus, or a second wallet, which is owned by an issuer of the transaction, as a payer of a fee for adding the block.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating a configuration of a system according to one embodiment.

FIGS. 2A-2B are a flowchart related to processing of a smart contract according to one embodiment.

FIG. 3 is a flowchart related to NFT issuance processing of a smart contract according to one embodiment.

FIG. 4 is a flowchart related to NFT purchase processing of a smart contract according to one embodiment.

FIG. 5 is a flowchart related to service information notification processing of a smart contract according to one embodiment.

FIG. 6 is a flowchart related to service termination notification processing of a smart contract according to one embodiment.

FIG. 7 is a block diagram related to an image forming apparatus according to one embodiment.

FIG. 8 is a sequence diagram from NFT issuance to NFT service termination notification according to one embodiment.

FIG. 9 is a flowchart related to NFT service information processing of an image forming apparatus according to one embodiment.

FIG. 10 is a block diagram related to a node (information processing apparatus) according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### <Configuration of System>

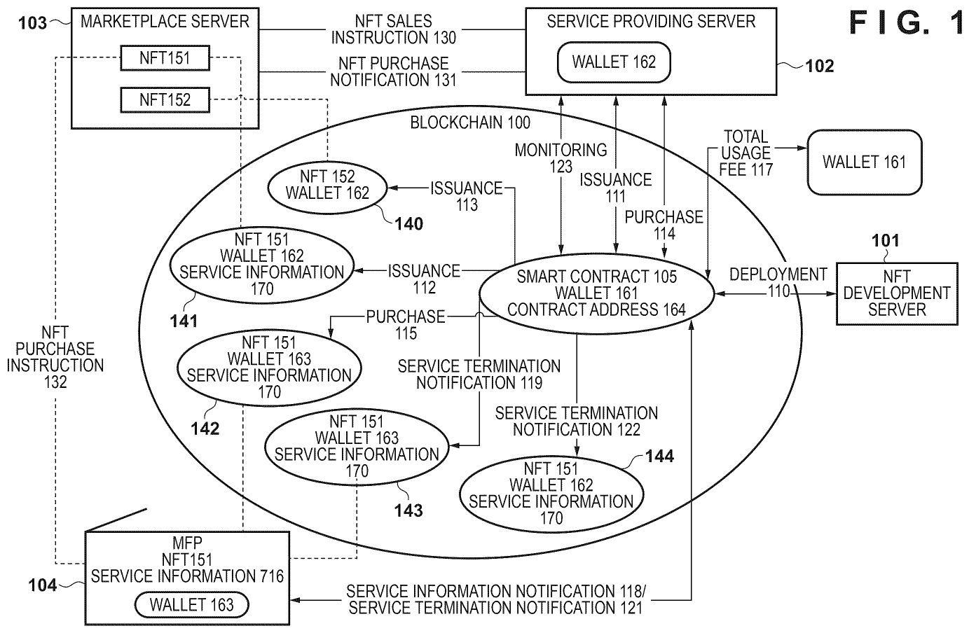

An embodiment of the present disclosure will be described below. An example of a configuration of a service providing system according to the present embodiment will be described with reference to FIG. 1. The system is configured to include a blockchain 100, an NFT development server 101, an information processing apparatus (MFP 104), a service providing server 102 which provides services to the MFP 104, and a marketplace server 103 which sells NFTs. Solid lines with arrows in FIG. 1 indicate transactions. Dotted lines indicate HTTP-based referencing, instruction, notification, and the like.

The blockchain 100 is a system constituted by an unspecified number of information processing apparatuses arranged as nodes and is also referred to as a distributed ledger. The respective nodes share history information of transaction data formed into blocks. The transaction data is held in a chain-like data structure, where details of immediately preceding transaction data are carried over as a hash. The transaction data (transaction) recorded in the blockchain 100 is characterized by being tamper-proof, lossless, and owner-identifiable.

The NFT development server 101 is a server of a company that develops a non-fungible token (NFT) contract block (smart contract 105). An NFT is digital data that includes owner information and is held in the blockchain as a block (NFT block) on the blockchain in association with a smart contract. NFTs have features such as anti-counterfeiting and proof of ownership. In the present embodiment, an NFT is associated with the number of printable sheets in a printing apparatus such as the MFP 104. In the present embodiment, description will be given using a non-fungible token (NFT) as an example of a transaction related to a token that includes usage information of a service in a blockchain network. However, there is no intention to limit the application of the present embodiment, and other tokens different from an NFT may be used.

The smart contract 105 is a program that is automatically executed using as a trigger of a transaction received from the blockchain or from outside the blockchain. The smart contract 105 is executed at any node (information processing apparatus) constituting the blockchain 100, and the execution result is shared among all nodes. The smart contract 105 according to the present embodiment executes processes, such as issuing an NFT, rewriting owner information of (purchasing) an NFT, notifying of service information of an NFT, and notifying of service termination of an NFT.

The service providing server 102 is a server of a company that sells NFTs that provide services. The provided services use an image forming apparatus (MFP 104) to support various forms of services in which an MFP is used, such as a print service, a rental service, and a maintenance service. Furthermore, the present embodiment can be applied to various services (emailing, WEB, content provision, gaming, etc.) provided over a network and in which an MFP is used as the information processing apparatus. The service providing server 102 issues an NFT according to the form of service in which an MFP is used and transmits an NFT sales instruction 130 to the marketplace server 103 in order to sell the issued NFT.

The marketplace server 103 is a Web server that displays, on a Web browser, pages for purchasing NFTs 151 and 152, which are sold on a marketplace. Upon execution of processing for purchasing an NFT 151 or 152 in the information processing apparatus or the MFP 104, an NFT purchase notification 131 is transmitted to the service providing server 102.

### (Deployment of NFTs)

Next, deployment of NFTs will be described. The NFT development server 101 is a server of a company that develops smart contracts that allow NFT issuance and sales in order to provide NFT services. The NFT development server 101 transmits a transaction for deployment 110 to the blockchain 100 and thereby deploys (arranges) the smart contract 105 in the blockchain 100. The smart contract 105 is assigned a contract address 164 at deployment, and a transaction is transmitted to the smart contract 105 by specifying the contract address 164.

The NFT development server 101 can provide a service in which an NFT is used by granting authority to the service providing server 102 to use the smart contract 105 to issue an NFT, rewrite the owner (make a purchase), and update NFT information. In the present embodiment, the smart contract 105 operates to accept processing of transactions from an address (public key) of a wallet 162 owned by the service providing server 102. The smart contract 105 also generates a wallet 161 and sets a wallet address of the wallet 161 to the smart contract 105 for payment of fees, which are required for generating transactions and adding NFT blocks, to the smart contract 105. The wallet 161 manages payment of fees for adding transactions related to issued NFTs to the blockchain 100. The fees described here are paid to nodes that executed computation work for verifying a block when adding the block to the blockchain 100 and for processing for adding the verified block at the end of a block as rewards for the computation.

The smart contract 105 stores the wallet address information in association with an NFT as an internal variable and transmits the wallet address information as a response at the time of NFT issuance such that the wallet 161 is managed on the service providing server 102. A wallet is a program that has a public and private key pair required for signature when adding a block to the blockchain 100 and manages tokens (virtual currency and NFTs) used in the blockchain 100. Account information for accessing the blockchain 100 is also held, and processing for approving processing for the blockchain 100 and the like are also executed through the wallet. The fees required for adding blocks of the blockchain 100 are a virtual currency (tokens) to be paid, as rewards for adding blocks, to nodes that performed verification of blocks to be added and addition of the blocks, which are executed at respective nodes constituting the blockchain 100.

### (Issuance of NFTs)

Next, issuance of NFTs will be described. The service providing server 102 issues NFTs and sells issued NFTs on the marketplace server 103. The service providing server 102 also monitors service information of an NFT service owned by the user and implements a procedure for terminating the service.

More specifically, the service providing server 102 first transmits a transaction for issuance 111, which is issuance of the NFT 151 or 152, to the smart contract 105. In issuance 111, a service name (NFT 151 or 152), service information 170, metadata, and the like are set. Upon receiving issuance 111, the smart contract 105 generates an NFT block 141 for the NFT 151 or an NFT block 140 for the NFT 152 in the blockchain 100 according to a transaction for issuance 112 or issuance 113. The owner of the NFT 151 or 152 is set to the address of the wallet 162 of the service providing server 102.

The issued NFTs 151 and 152 are each assigned a unique ID (token ID), and an NFT can be referenced and processed by transmitting a transaction to a URI indicated by the token ID and the contract address of the smart contract 105. The service providing server 102 sets sales prices for the NFTs 151 and 152 and transmits the NET sales instruction 130 to the marketplace server 103 to sell the issued NFTs.

### (Purchase of NFTs)

Next, purchase of NFTs will be described. When purchasing an NFT service, the MFP 104 selects the NFT 151 on the marketplace server 103 and transmits an NFT purchase instruction 132, which includes a wallet address of a wallet 163, to the marketplace server 103 to purchase the NFT. Upon accepting the NFT purchase instruction 132, the marketplace server 103 transmits the NFT purchase notification 131, which includes the wallet address of the wallet 163, to the service providing server 102. After accepting the NFT purchase notification 131, the service providing server 102 transmits a transaction for purchase 114 to the smart contract 105 in order to change the owner information of the NFT 151 to the wallet 163 of the MFP 104 that made the purchase.

After receiving the purchase 114, the smart contract 105 uses tokens held in the wallet 163 to implement a payment for purchasing the NFT, with some tokens being transmitted to the wallet 161 as a total fee 117 and the rest being transmitted to the wallet 162. The smart contract 105 also changes the owner of the NFT 151 from the wallet 162 to the wallet address of the wallet 163 according to a transaction for purchase 115 and adds an NFT block 142 to the blockchain 100. As described above, according to the present embodiment, when a transaction for purchase 114 is received by the smart contract 105, tokens are transferred.

### (Start of NFT Service)

Next, the start of NFT service will be described. An NFT service of the MFP 104 starts the NFT service according to the NFT 151 when the block 142 for the NFT 151 is added to the blockchain 100 after the MFP 104 purchases the NFT 151. The service providing server 102 can confirm a service start date according to the NFT block 142 for the NFT 151. The MFP 104 may also install applications, data, and the like necessary for the MFP 104 based on metadata of the NFT 151 after the start of the NFT service.

### (Service Information Notification)

Next, service information notification will be described. When executing a service provided by the NFT 151, the MFP 104 transmits a service information notification 118 to the smart contract 105. For example, if the service provided is a print service, after executing the printing function the MFP 104 transmits the actual number of printed sheets to the smart contract 105 by using the service information notification 118.

Here, the payer of the fee at the time of generating a transaction for the service information notification 118 is set to the wallet 161 of the smart contract 105. When the smart contract 105 receives the service information notification 118 from the MFP 104, the service information 170 stored in the NFT 151 is rewritten according to a service information notification 119, and an NFT block 143 is added to the blockchain 100. The smart contract 105 also sets the wallet 161 as the payer of the fee at the time of generating the transaction for the service information notification 119.

The token balance of the wallet 161 has tokens from total fees for the service information notifications 118 and 119 at the time of NFT purchase, and the fee for one service information notification can be paid from the wallet 161. Here, the token balance of the wallet 161 may be 0 due to fluctuations in fees or the like. In this case, the smart contract 105 may transfer tokens from the wallet 162 of the service providing server 102 to the wallet 161 or change the wallet of the payer to the wallet 162 of the service providing server 102.

### (Service Monitoring)

Next, service monitoring will be described. The service providing server 102 confirms a change in service information 716 of the MFP 104 by transmitting a transaction for monitoring 123 to the smart contract 105. Upon receiving monitoring 123, the smart contract 105 obtains the service information 170 of the issued NFT, sets the service information 170 as a response to monitoring 123, and transmits it to the service providing server 102.

### (Service Termination Notification)

Next, service termination notification will be described. When terminating the service of the NFT 151 being provided to the MFP 104, the MFP 104 transmits a service termination notification 121 to the smart contract 105. Upon receiving the service termination notification 121, the smart contract 105 generates an NFT block 144 according to the transaction for the service termination notification 122 and terminates the service. The NFT block 144 indicates that the service provided by the NFT 151 has been terminated by changing the owner of the NFT 151 to the wallet 162 of the service providing server 102. By receiving a response to the service termination notification 121, the MFP 104 stops the service notification function operating in the MFP 104. The service providing server 102 monitors the NFT 151 sold through the smart contract 105 and determines the termination of the service of the MFP 104 based on the NET block 144.

If there are remaining tokens in the wallet 161 when terminating the service of the NFT 151, the smart contract 105 may transmit the remaining tokens to the wallet 163 of the MFP 104. Alternatively, if there is remaining token balance in the wallet 161 at the time of service termination notification, the smart contract 105 may transmit the remaining balance worth of tokens to the wallet 162 of the service providing server 102.

As described above, the overview of a service information management system in which NFTs are used has been described according to the system configuration diagram of FIG. 1. As described above, by using the NFT 151 and the smart contract 105, the present technology can construct a system that can provide various services in which the MFP 104 is used. By using NFTs, the service providing server 102 can also manage, on the blockchain, a series of operations from installing applications and service information of the MFP 104 to monitoring the service information and terminating the services. The present technology can also provide a service system that is tamper-proof, whose history can easily be confirmed (traceable), and whose authenticity is guaranteed (owner-identifiable), which are characteristics of a blockchain.

### <Configuration of Node (Information Processing Apparatus)>

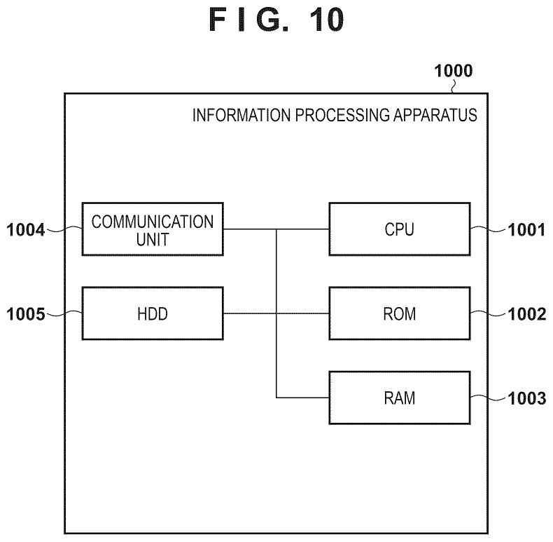

An example of a hardware configuration of an information processing apparatus 1000 as an example of a node according to the present embodiment will be described with reference to FIG. 10. The information processing apparatus 1000 includes a CPU 1001, a ROM 1002, a RAM 1003, a communication unit 1004, and an HDD 1005.

The CPU 1001 executes processes by executing programs such as the smart contract 105 stored in the ROM 1002 or the HDD 1005. The ROM 1002 stores the above programs. The RAM 1003 is used as a temporary storage region such as a main memory and a work area of the CPU 1001. The HDD 1005 stores various kinds of information related to the blockchain, such as NFTs, wallets, contract addresses, service information, and the like in addition to programs.

The communication unit 1004 can exchange data with other nodes and various devices such as the NFT development server 101, the service providing server 102, the marketplace server 103, and the MFP 104. The communication unit 1004 may perform wired communication in which Ethernet® is used or radio communication such as Wi-Fi.

### <Processing Procedure of Smart Contract 105>

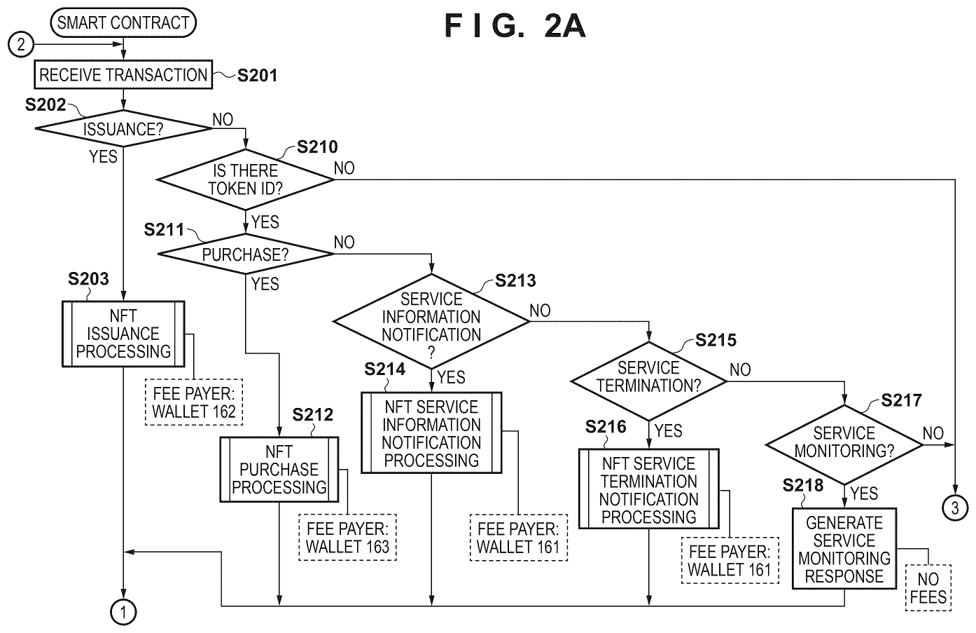

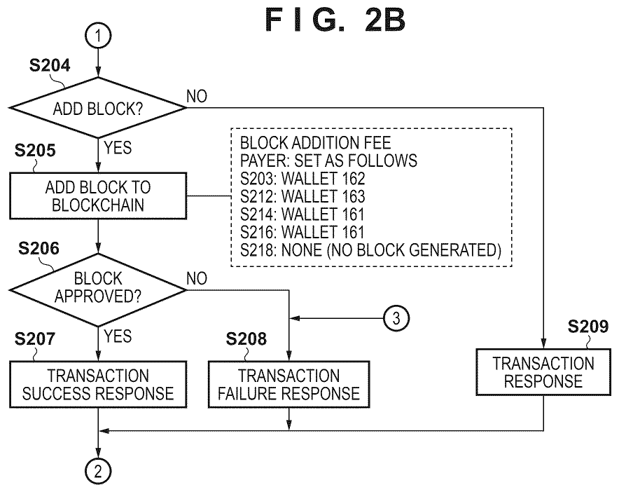

The processing procedure of the smart contract 105 according to the present embodiment will be described with reference to FIGS. 2 to 6. The smart contract 105 has an address of the blockchain 100 and, when a transaction is transmitted to this address, executes the processing described in the transaction. The smart contract 105 according to the present embodiment processes issuance, purchase, service information notification, and service termination notification. Further, details of a transaction describe the token ID, the owner, the fee payer, the token payer, the token payee, and the like. The token ID is an ID assigned to an NFT issued by the smart contract 105. As for the owner, the fee payer, the token payer, and the token payee, wallet addresses are described.

FIGS. 2A-2B are a flowchart indicating a processing procedure related to issuance, purchase, service information notification, service termination notification, and service monitoring of an NFT by the smart contract 105 according to the present embodiment. The processing to be described below is realized by, for example, the CPU 1001 of the information processing apparatus 1000, which executes a program of the smart contract 105, reading out a program stored in the ROM 1002 or the HDD 1005 to the RAM 1003 and executing the program. In the following description, the number that follows “S” indicates a step number of the processing in the flowchart or sequence.

In step S201, the smart contract 105 receives a transaction transmitted to the smart contract 105 from, for example, the service providing server 102 or the MFP 104. After receiving the transaction, the smart contract 105 analyzes the details of the processing requested by the transaction and executes respective processing according to the analysis result. In step S202, the smart contract 105 determines whether the processing requested by the received transaction is an issuance, and when it is an issuance (YES), transitions to step S203, and when it is not an issuance (NO), transitions to step S210.

In step S203, the smart contract 105 executes NFT issuance processing. Here, the smart contract 105 sets the wallet 162 of the service providing server 102 as the payer of the fee for adding an NFT block or a transaction block to the blockchain 100. Then, in step S204, the smart contract 105 determines whether to add a block to the blockchain 100, and if it is to be added (YES), transitions to step S205, and if it is not to be added, transitions to step S209.

In step S205, the smart contract 105 adds an NFT block or a transaction that has been generated in step S203, S212, S214, or S216 to the blockchain 100. At this time, if the processing has gone through step S203 (NFT issuance processing), the smart contract 105 sets the wallet 162 of the service provider as the payer of the fee for adding an NFT block or a transaction block to the blockchain 100. If the processing has gone through step S212 (NFT purchase processing), the wallet 163 of the service user who purchased the NFT is set. Here, the wallets 162 and 163 correspond to a second wallet owned by the issuer of the transaction. In a case where processing has gone through step S214 (NFT service information notification processing) and in a case where processing has gone through step S216 (NFT service termination notification processing), the wallet 161 set in the smart contract 105 is set. The wallet 161 corresponds to a first wallet owned by a node (information processing apparatus) that executes the smart contract 105. Here, by setting the wallet 161 of the smart contract 105, payments from the MFP 104 of the service user need not be made for blockchain usage fees at the time of NFT service information notification and NFT service termination notification processing.

In step S206, the smart contract 105 determines the result of validation and approval for a block to be added in the blockchain 100, and if block addition has been approved (YES), transitions to step S207, and if not approved (NO), transitions to step S208. In step S207, the smart contract 105 transmits a transaction success response to the transaction sender and returns the processing to step S201. The address information of the NFT block generated when the transaction is successful is associated with the token ID of the NFT and stored in the smart contract 105.

Meanwhile, in step S208, the smart contract 105 transmits a transaction failure response to the transaction sender and returns the processing to step S201. Further, if it is determined in step S204 that the block is not to be added, in step S209, the smart contract 105 transmits the transaction response generated in the respective processing to the transaction sender and returns the processing to step S201.

If it is determined in step S202 that it is not an issuance, in step S210 the smart contract 105 determines whether there is a token ID in the received transaction, and if there is (YES), transitions to step S211, and if there is none (NO), transitions to step S208. In step S211, the smart contract 105 determines whether the processing of the received transaction is a purchase, and when it is a purchase (YES), transitions to step S212, and when it is not a purchase (NO), transitions to step S213. In step S212, the smart contract 105 executes NFT purchase processing and transitions to step S204. Here, the smart contract 105 sets the wallet 163 of the service user (MFP 104) as the payer of the fee for adding an NFT block or a transaction block to the blockchain 100.

If it is determined in step S211 that it is not a purchase, in step S213 the smart contract 105 determines whether the processing of the received transaction is a service information notification. Here, if it is a service information notification (YES), the processing transitions to step S214, and if it is not a service information notification (NO), the processing transitions to step S215. In step S214, the smart contract 105 executes NFT service information notification processing and transitions to step S204. Here, the smart contract 105 sets the wallet 161 set in the smart contract 105 as the payer of the fec for adding an NFT block or a transaction block to the blockchain 100.

If it is determined in step S213 that it is not a service information notification, in step S215 the smart contract 105 determines whether the processing of the received transaction is a service termination notification. Here, if it is a service termination notification (YES), the processing transitions to step S216, and if it is not a service termination notification (NO), the processing transitions to step S217. In step S216, the smart contract 105 executes NFT service termination notification processing and transitions to step S204. Here, the smart contract 105 sets the wallet 161 set in the smart contract 105 as the payer of the fee for adding an NFT block or a transaction block to the blockchain 100.

If it is determined in step S215 that it is not a service termination notification, in step S217 the smart contract 105 determines whether the processing of the received transaction is service monitoring. Here, if it is service monitoring (YES), the processing transitions to step S218, and if it is not service monitoring (NO), the processing transitions to step S208. In step S218, in order to generate a response for service monitoring, if the address of the transaction sender is the service provider (service providing server), the smart contract 105 sets the service information 170 set in the NFT as a response. Meanwhile, if it is not a service provider, service information unobtainable is set as a response. At this time, since an NFT block or a transaction block is not added to the blockchain 100, no fees are paid. Then, the processing transitions to step S204.

The processing of smart contract 105 related to issuance, purchase, service information notification, service termination notification, and service monitoring in the NFT service has thus been described. The smart contract 105 can thus execute from general processing, such as issuance and purchase in which NFTs are used, to processing related to provided services, such as service information notification, service termination notification, and service monitoring. The smart contract 105 can also support various services by increasing the number of determination branches of steps S211, 213, 215, and 217. The wallet to be the payer of the fee according to the executed processing can be individually set at each branch.

### <NFT Issuance Processing>

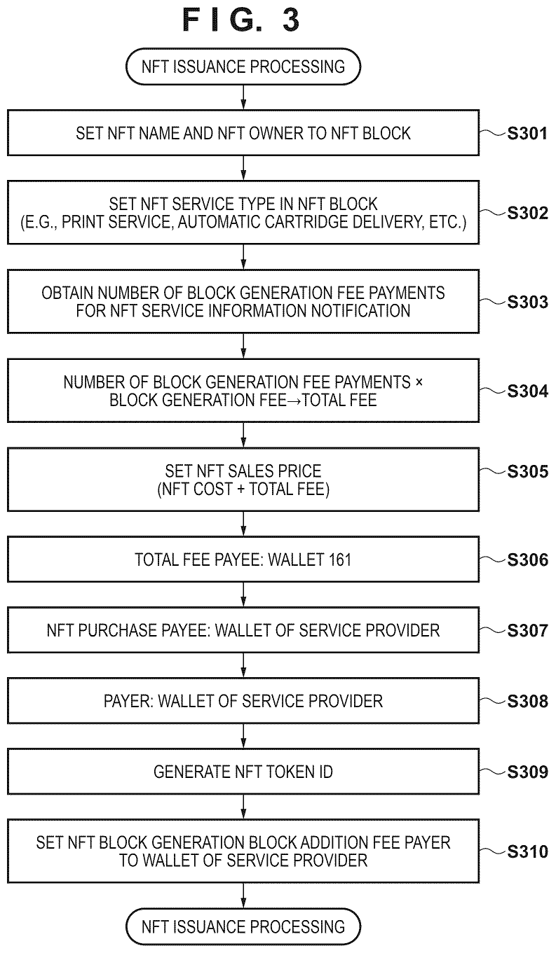

A processing procedure of NFT issuance processing (step S203) by the smart contract 105 according to the present embodiment will be described in detail with reference to FIG. 3. The processing to be described below is realized by, for example, the CPU 1001 of the information processing apparatus 1000, which executes a program of the smart contract 105, reading out a program stored in the ROM 1002 or the HDD 1005 to the RAM 1003 and executing the program. In issuance of an NFT, details to be set in an NFT block are set in order to generate an NFT block.

In step S301, the smart contract 105 sets an NFT name and an NFT owner. In the case of issuance 112 of FIG. 1, the NFT 151 is set as the NFT name and the wallet 162 is set as the NFT owner. Then, in step S302, the smart contract 105 sets an NFT service type in an NFT block. The information to be notified in the NFT to the smart contract 105 changes depending on the service type set in step S302.

In step S303, the smart contract 105 obtains the number of fee payments for blocks to be added to the blockchain 100 for NFT service information notification. For example, in the case of a print service, the smart contract 105 sets the number of blocks to be generated on the blockchain based on the number of printed sheets to be provided by the NFT. Then, in step S304, the smart contract 105 multiplies the number of block addition fee payments and the block addition fee to obtain the total fee required for block addition. In step S305, the smart contract 105 sets tokens (amount) at which the NFT is sold. Regarding the amount of tokens at which a sale is made, an amount of tokens (total amount) that is a combination of the amount of tokens for an NFT for service provision and the total fee obtained in step S304 is set.

In step S306, the smart contract 105 sets the wallet 161 prepared by an NFT developer as the fee payer. In step S307, the smart contract 105 sets the payee at the time of NFT purchase to the wallet of the service provider. In step S308, the smart contract 105 sets the payer of tokens required for NFT issuance to the wallet of the service provider. In step S309, the smart contract 105 generates the token ID of the NFT. Token IDs are generated as unique IDs for all issued NFTs. In step S310, the smart contract 105 generates an NFT block. The payer of fees for adding blocks is set to the wallet of the service provider.

### <NFT Purchase Processing>

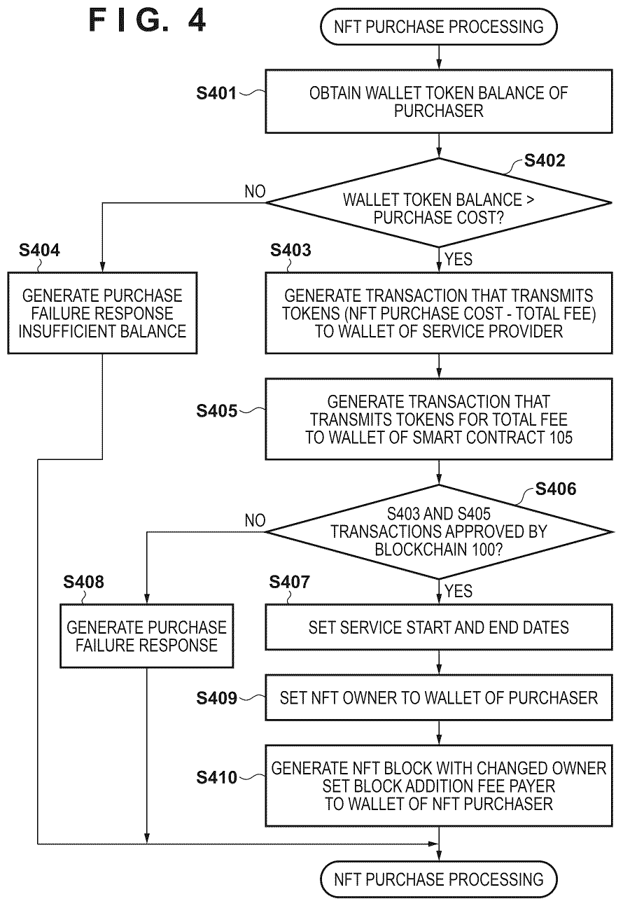

A processing procedure of NFT purchase processing (step S212) by the smart contract 105 according to the present embodiment will be described in detail with reference to FIG. 4. The processing to be described below is realized by, for example, the CPU 1001 of the information processing apparatus 1000, which executes a program of the smart contract 105, reading out a program stored in the ROM 1002 or the HDD 1005 to the RAM 1003 and executing the program.

In step S401, the smart contract 105 obtains the token balance of the wallet of the purchaser. In step S402, the smart contract 105 determines whether the token balance of the wallet of the purchaser is greater than the amount of tokens required for purchase, and if greater (YES), transitions to step S403 and if less (NO), transitions to step S404. In step S404, the smart contract 105 generates a purchase failure response, which includes information that the balance is insufficient and terminates the processing of the flowchart.

Meanwhile, in step S403, the smart contract 105 generates a transaction that transmits the amount of tokens obtained by subtracting the total fee from the NFT purchase cost to the wallet of the service provider. Then, in step S405, the smart contract 105 generates a transaction that transmits tokens for the total fee to the wallet (wallet 161) of the smart contract 105. In step S406, it is determined whether the transactions generated in the above steps S403 and S405 have been approved by the blockchain, and if approved (YES), the processing transitions to step S407, and if not approved (NO), the processing transitions to step S408. In step S408, the smart contract 105 generates a purchase failure response in the blockchain 100 and terminates the processing of the flowchart.

In step S407, the smart contract 105 sets a service start date and a service end date based on service details as information of the NFT block. By setting the service end date at the time of purchase, the service can be automatically terminated from the smart contract 105. In step S409, the smart contract 105 sets the owner of the NFT to the wallet address of the purchaser.

In step S410, the smart contract 105 generates an NFT block in which the owner has been changed. The payer of fees for adding NFT blocks to the blockchain is set as the wallet (wallet 163) of the MFP 104 (service user).

### <Service Information Notification Processing>

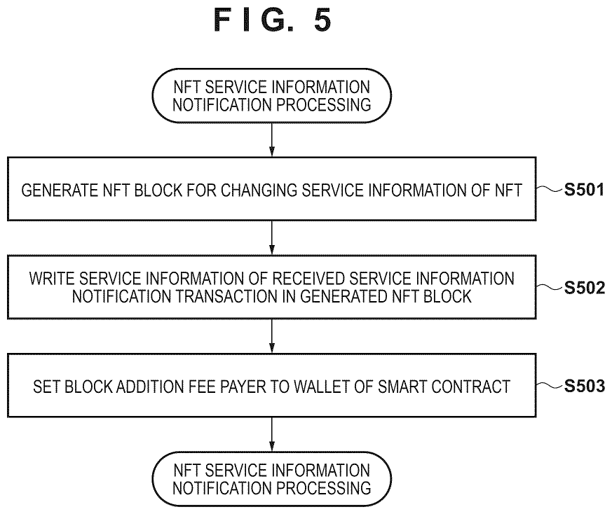

A processing procedure of NFT service information notification processing (step S214) by the smart contract 105 according to the present embodiment will be described in detail with reference to FIG. 5. The NFT service information notification adds an NFT block in which the service information 170 held in the NFT has been changed to the blockchain 100 in order to generate an NFT block. The processing to be described below is realized by, for example, the CPU 1001 of the information processing apparatus 1000, which executes a program of the smart contract 105, reading out a program stored in the ROM 1002 or the HDD 1005 to the RAM 1003 and executing the program.

In step S501, the smart contract 105 generates an NFT block for changing the service information 170 of the NFT. Then, in step S502, the smart contract 105 obtains the service information 716 of the MFP 104 from the transaction for the service information notification 118 received from the MFP 104 in step S201 and writes it in the service information 170 of the NET block generated in step S501. Here, the smart contract 105 may accept payment of tokens for extending the service by a transaction for service information notification. In such a case, the NFT service can be extended by extending the service termination notification date of the NFT. In step S503, the smart contract 105 sets the wallet 161 of the smart contract 105 as the payer of fees for adding NFT blocks and terminates the processing of the flowchart.

### <Service Termination Notification Processing>

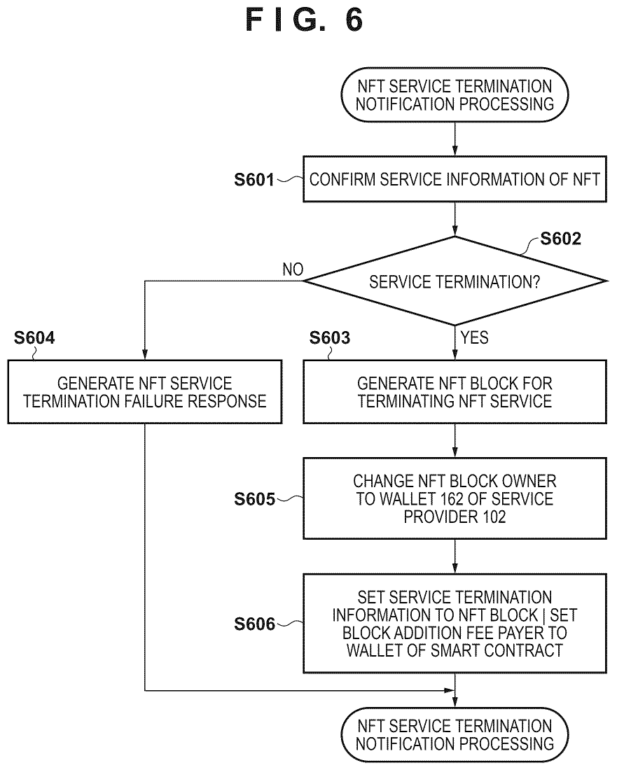

A processing procedure of NFT service termination notification processing (step S216) by the smart contract 105 according to the present embodiment will be described in detail with reference to FIG. 6. The NFT service termination notification changes the service status held in the NFT to a terminated status and adds an NFT block to the blockchain 100 in order to generate an NFT block in which service termination is notified. The processing to be described below is realized by, for example, the CPU 1001 of the information processing apparatus 1000, which executes a program of the smart contract 105, reading out a program stored in the ROM 1002 or the HDD 1005 to the RAM 1003 and executing the program.

In step S601, the smart contract 105 confirms the service status of the NFT and confirms whether a termination condition is met based on the service termination notification date, service information, and the like. In step S602, the smart contract 105 determines whether the service termination condition is met, and if met (YES), transitions to step S603, and if not met (NO), transitions to step S604. In step S604, the smart contract 105 generates an NFT service termination notification failure response for a transaction for NFT service termination notification, and terminates the processing of the flowchart.

Meanwhile, in step S603, the smart contract 105 generates an NFT block for NFT service termination notification. Then, in step S605, the smart contract 105 changes the owner of the generated NFT block from the wallet of the MFP 104 to the wallet of the service provider. Furthermore, in step S606, the smart contract 105 sets service termination notification information in the generated NFT block and terminates the processing of the flowchart. Here, the wallet 161 of the smart contract 105 is set as the payer of fees for NFT block addition.

### <Hardware Configuration of MFP>

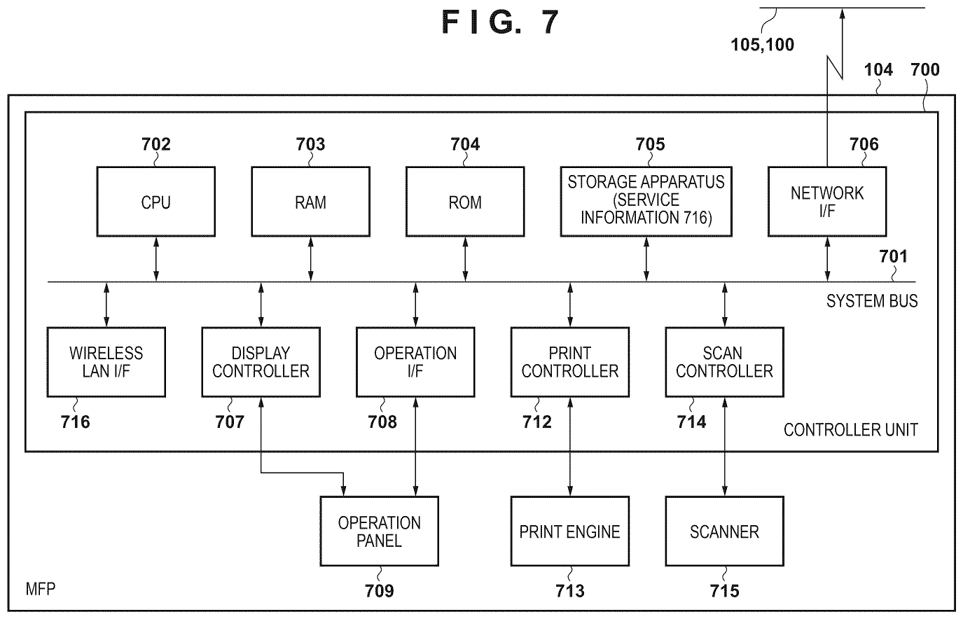

An example of a hardware configuration of a controller unit 700 of the MFP 104 according to the present embodiment and devices incorporated in the MFP will be described with reference to FIG. 7. Services provided by the MFP 104 can be used by purchasing NFTs sold on the marketplace server 103.

The MFP 104 includes the controller unit 700, an operation panel 709, a print engine 713, and a scanner 715. The controller unit 700 includes a CPU 702, a RAM 703, a ROM 704 and a storage apparatus 705, and these respective units are directly connected to a system bus 701. The controller unit 700 also includes a network I/F 706, a display controller 707, a processing I/F 708, a print controller 712, and a scan controller 714 and is connected to external devices through these respective units. These components are connected to the system bus 701 and are capable of communicating with each other.

The CPU 702 is a central processing unit that controls the entire operation of the controller unit 700. The RAM 703 is a volatile memory. The ROM 704 is a non-volatile memory and stores a startup program for the CPU 702. The storage apparatus 705 is a larger capacity storage apparatus (e.g., a hard disk drive (HDD)) compared to the RAM 703. The storage apparatus 705 stores a control program for the MFP to be executed by the CPU 702. The storage apparatus 705 may be replaced by another storage apparatus that has functions equivalent to a hard disk drive, such as a solid state drive (SSD). The storage apparatus 705 also includes the wallet 163 of the MFP 104 for accessing the blockchain 100, which holds information on the address on the blockchain 100 as well as virtual currency (tokens), a private key, a public key, and NFT information. The NFT information includes the name of an NFT owned by the MFP, an NFT token (contract address and token ID), a token URI, a description of the NFT, and the like. The storage apparatus 705 also stores an NFT service program for setting the wallet to be used for transaction generation to the wallet 161 of the smart contract 105 when using the NFT service. The NFT service program is executed by the CPU 702 by deploying a program in the RAM 703 after the start of the NFT service.

The CPU 702 executes the startup program stored in the ROM 704 at startup such as power-on. The startup program reads out the control program stored in the storage apparatus 705, deploys the program on the RAM 703 and executes the program. The CPU 702 executes the startup program and then executes the control program deployed on the RAM 703 to perform control. The CPU 702 stores data, which is used when executing the control program, on the RAM 703 and reads and writes the data. The storage apparatus 705 can further store various settings necessary for when executing the control program, image data read by the scanner 715, the service information 716 for management by the NFT 151, which are read and written by the CPU 702.

The CPU 702 communicates with the smart contract 105 and the nodes (information processing apparatuses) of the blockchain 100 via the network I/F 706 and with the marketplace server 103 on the Internet via a gateway. The MFP 104 also stores in the ROM 704 the service information notification 118 for notifying the smart contract 105 of the service information 716, and the control program for transmitting a transaction for the service termination notification 121 for terminating a service.

The display controller 707 performs screen display control of the touch panel on the connected operation panel 709 in response to an instruction from the CPU 702. The processing I/F 708 inputs and outputs processing signals. The processing I/F 708 is connected to the operation panel 709, and the CPU 702 obtains the coordinates pressed by the touch panel through the processing I/F 708 when the touch panel is pressed. The print controller 712 transmits control commands and image data to the connected print engine 713 in response to an instruction from the CPU 702. The print engine 713 prints the received image data on a sheet according to a control command received from the print controller 712. Since the detailed description of the print engine 713 is not the main focus of the present embodiment, further description will be omitted.

The scan controller 714 transmits a control command to the connected scanner 715 in response to an instruction from the CPU 702 and writes image data received from the scanner 715 in the RAM 703. The scanner 715 reads a document on a document platen glass (not illustrated) provided in the MFP 104 or a document placed on an ADF using an optical unit according to a control command received from the scan controller 714. The document read by the scanner 715 is stored in the RAM 703 as image data, and the image data is converted into a PDF/JPEG/TIFF file format by the CPU 702 according to the setting for the file format and stored in the storage apparatus 705.

### <Sequence>

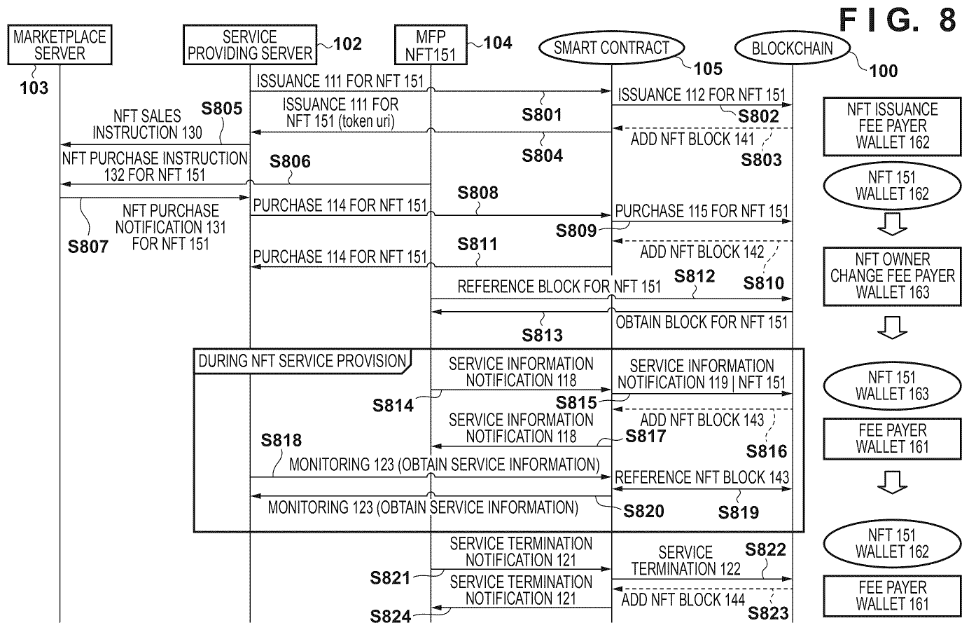

A sequence from NFT issuance and start of service for an MFP that purchased an NFT to service termination notification in the service providing system according to the present embodiment will be described with reference to FIG. 8. Here, the sequence between respective apparatuses, the blockchain 100, the smart contract 105, the MFP 104, the service providing server 102, and the marketplace server 103, is indicated.

In step S801, the service providing server 102 transmits the issuance 111 to the smart contract 105 to issue the NFT 151. In step S802, the smart contract 105 requests the blockchain 100 to approve addition of an NFT block for the NFT 151 according to the issuance 112. Upon approval of the block for the NFT 151, the blockchain 100 sets the owner of the NFT 151 to the wallet 162 and adds the block to the blockchain 100. The payer for adding an NFT block and a transaction according to the issuance 112 is the wallet 162 of the service providing server 102.

In step S803, the smart contract 105 confirms that the NET block 141 in which the owner of the NFT 151 has been set to the wallet 162 has been added to the blockchain 100. In step S804, the smart contract 105 transmits that the NET block 141 for the NFT 151 has been generated to the service providing server 102 as a response to issuance 111. In step S805, the service providing server 102 transmits the NET sales instruction 130 to the marketplace server 103 to sell the NFT 151 on the marketplace server 103.

Next, in step S806, the MFP 104 transmits a purchase instruction 132 for the NFT 151 in which the wallet 163 is used to the marketplace server 103. In step S807, the marketplace server 103 transmits the NFT purchase notification 131, which includes the wallet address of the wallet 163, to the service providing server 102 to notify the service providing server 102 of a purchase of the NFT 151. In step S808, the service providing server 102 transmits, to the smart contract 105, the purchase 114 for changing the owner of the NFT 151 to the wallet 163 and starts the processing for purchasing the NFT 151.

In step S809, the smart contract 105 requests the blockchain 100 to approve addition of an NFT block for the NFT 151 and waits for the NFT block for the NFT 151 to be added to the blockchain 100. The payer of fees for adding an NFT block and a transaction at the time of purchase to the blockchain is set to the wallet 163 that instructed the purchase. In step S810, the smart contract 105 confirms that the NFT block 142 for the NFT 151 whose owner has been changed to the wallet 163 has been added to the blockchain 100. In step S811, the smart contract 105 notifies the service providing server 102 that the NFT 151 has been purchased by the MFP 104 as a response to the purchase 114. In step S812, the MFP 104 references the NFT block 142 for the NFT 151 to confirm the owner of the NFT 151. Furthermore, in step S813, upon confirming that the owner of the NFT 151 is the wallet 163, the MFP 104 starts the NFT service. The MFP 104 obtains information for the NFT service from the NFT block 142 for the NFT 151, obtains required information, installs applications, and the like.

Subsequent steps S814 to S820 are a sequence during NFT service provision, and a sequence based on NFT service information notification 118 and monitoring 123 is repeatedly executed. In step S814, the MFP 104 transmits the NFT service information notification 118 to the smart contract 105 at the timing of notifying the service information 716 of the NFT. In step S815, the smart contract 105 requests the blockchain 100 to approve the NFT block 142 in which the service information 170 of the NFT 151 has been updated according to the service information notification 119. Here, the payer of the fee for adding an NFT block in which the service information 170 of the NFT 151 has been updated is set to the wallet 161 of the smart contract 105. The fee is paid as a reward for computational processing to the node that added the NFT block of the blockchain 100. In step S816, the smart contract 105 confirms that the NFT block 142 in which the service information 170 has been updated has been added to the blockchain 100. In step S817, the smart contract 105 transmits a response for the service information notification 118 to the MFP 104.

In step S818, the service providing server 102 transmits the monitoring 123 to the smart contract 105 to monitor the service information 170 of the NFT 151. In step S819, the smart contract 105 references the NFT block 143 of the blockchain and obtains the service information 170 included in the NFT block 143. In step S820, the smart contract 105 transmits the service information 170 obtained in step S819 to the service providing server 102 as a response to the monitoring 123.

In step S821, the MFP 104 transmits the service termination notification 121 to the smart contract 105 at the timing for terminating the service of the NFT 151. In step S822, the smart contract 105 transmits the service termination notification 122 to the blockchain 100 and thereby requests the blockchain 100 to approve the block 144 in which the owner of the NFT 151 has been changed to the wallet 162. Here, the payer of the fee for adding an NFT block for the NFT 151 according to the service termination notification 122 is set to the wallet 161 of the smart contract 105. In step S823, the smart contract 105 confirms that the NFT block 144 in which the owner has been updated to the wallet 162 according to the service termination notification 121 has been added to the blockchain 100. In step S824, the smart contract 105 transmits a response for the service termination notification 121 to the MFP 104.

The sequence of a service information notification system at the time of service provision for the MFP 104 by the smart contract 105 has thus been described with reference to FIG. 8. As described above, the service providing server 102 can monitor the service information 716 of an MFP of the service user by using the smart contract 105 and can automatically start and terminate the provided service. By transferring the owner of the NFT 151 to the wallet 163 of the MFP 104, a service start date can also be set. By the smart contract 105 deciding the service termination notification date on the service start date and the MFP 104 can determine the service termination notification date by obtaining the service information of the NFT 151. By thus using a smart contract, an NFT-based service providing system can flexibly construct various processes.

### <Flow of NFT Service Information Notification Processing of MFP>

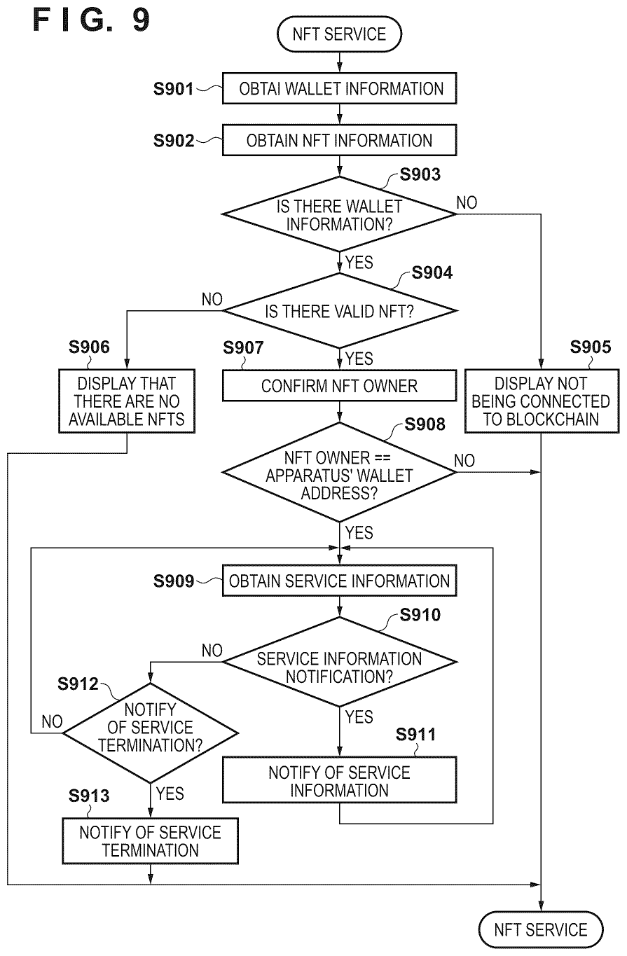

A processing procedure related to NFT service information notification of the MFP 104 according to the present embodiment will be described with reference to FIG. 9. The processing to be described below is realized, for example, by the CPU 702 reading out a program stored in the ROM 704 or the storage apparatus 705 to the RAM 703 and executing the program. The flowchart starts when a function related to NFT service information notification is enabled.

In step S901, the CPU 702 obtains wallet information stored in the storage apparatus 705 of MFP 104. The wallet information includes a control program for communicating with the blockchain 100, account information, private and public key information required at the time of block addition, and the like. When accessing a block of the blockchain 100, the wallet uses a wallet program to access one of the nodes constituting the blockchain 100, transmits a transaction, and by receiving a response, enables communication with the blockchain. The wallet also holds authentication information and executes authentication processing at the time of accessing the blockchain 100.

In step S902, the CPU 702 obtains NFT information stored in the storage apparatus 705. NFT information is stored at the time of purchase, and the service information 170 to be notified to the blockchain 100 is determined based on the enabled function and the service information 170 provided by the NFT. In step S903, the CPU 702 determines whether there is a wallet based on the wallet information read from the storage apparatus 705, and if there is a wallet (YES), transitions to step S904, and if there is none (NO), transitions to step S905. In step S905, the CPU 702 displays on the operation panel 709 there being no wallet information and that it is not connected to the blockchain, and terminates the processing of the flowchart.

In step S904, the CPU 702 accesses the blockchain 100 based on the read NFT information and reads the NFT block. If the owner of the NFT is the wallet address of the wallet read in step S901, it is determined that the NFT service is functioning and that there is a valid NFT (YES), and the processing transitions to step S907. Meanwhile, if it is determined that there are no valid NFTs (NO), the processing transitions to step S906. In step S906, the CPU 702 displays on the operation panel 709 that there are no available NFTs and terminates the processing of the flowchart.

Meanwhile, in step S907, the CPU 702 obtains NFT information from the blockchain 100 and confirms the owner of the NFT. In step S908, the CPU 702 confirms whether the NFT owner obtained in step S907 and its wallet address are the same, and if they are the same (YES), transition to step S909, and otherwise, terminates the processing of the flowchart.

In step S909, the CPU 702 obtains the service information 716 to be notified to the notification destination of NFT service information notification. In step S910, the CPU 702, if there is the service information 716 to be notified to the smart contract 105 (YES), transitions to step S911, and if there is no service information 716 (NO), transitions to step S912. In step S911, the CPU 702 transmits a service information notification to the smart contract 105 and returns the processing to step S909.

In step S912, the CPU 702 determines whether a service termination notification condition such as the NFT service end date, has been met, and if the service termination notification condition is met (YES), transitions to step S913, and if the service termination notification condition is not met (NO), transitions to step S909. In step S913, the CPU 702 transmits a service termination notification to the smart contract 105 and terminates the processing of the flowchart.

The flowchart of NFT service information notification processing of the MFP 104 has thus been described with reference to FIG. 9. By thus notifying the service information notification 118 and the service termination notification 121 from the MFP 104 to the smart contract 105, the NFT service can be implemented in the MFP 104. For example, in the case of a print count service, the print count service of the MFP 104 can be realized by notifying the number of printed sheets using the service information notification 118 and by performing notification using the service termination notification 121 when the upper limit of the print count service is reached. Further, in the case of performing a consumable delivery service in the MFP 104, the service provider can manage the delivery of consumables by monitoring 123 by notifying the smart contract 105 of the service information notification 118 at a timing when the consumables of the MFP 104 becomes small.

As described above, a computer program according to the present embodiment causes a computer of an information processing apparatus (node) that executes a smart contract to function as follows. That is, the computer program causes the computer to function so as to, in a blockchain network, receive a transaction related to a token that includes usage information of a service, and execute processing requested by the received transaction. The computer program also causes the computer to function so as to determine whether to add a block to a blockchain according to the executed processing. The computer program also causes the computer to, in a case of adding the block, set a first wallet, which is owned by the information processing apparatus, or a second wallet, which is owned by an issuer of the transaction, as a payer of a fee for adding the block. This makes it possible to suitably pay a fee at the time of using a service in a blockchain network. As described above, according to the smart contract of the present embodiment, a user of a printing apparatus can collectively pay fees and service usage fees that are generated each time the service is used when purchasing an NFT. The fees paid in advance are transferred to the wallet (first wallet) of the smart contract, and the fees are paid from the wallet each time the service is used. Therefore, if a user of a service pays a predetermined fee when purchasing an NFT, they will not need to pay a fee each time they use the service. This makes it possible to reduce the user's reluctance to use the service.

### Modification

The technology according to the present disclosure is not limited to the above embodiment, and various modifications are possible. In the above embodiment, an example in which a non-fungible token (NFT) is used as a token has been described. However, other tokens may be used depending on the form in which the service is provided. For example, a token can be applied to the technology of the present disclosure so long as it is capable of ownership or value transfer.

Further, in the above-described embodiment, an embodiment has been described in which a part of the fee paid at the time of purchasing NFT is pooled to the wallet of the smart contract and the fee paid for each use of the service is paid from the wallet of the smart contract. Here, there may be cases where there is remaining pooled balance (amount of tokens) after printing the number of printable sheets granted by purchasing an NFT, in which case the remaining amount may be returned in the number of printable sheets. Meanwhile, when the pooled balance is insufficient, control to replenish from the wallet of the service provider, for example, may be performed.

Further, some of the fees paid at the time of NFT purchase may be pooled in the wallet of the service provider. In this case, the service provider can provide a service to increase the number of printable sheets when the balance of the wallet is high. Further, the pooled balance may be made available as a temporary payment when the number of printable sheets is insufficient.

According to the technology of the present disclosure, it is possible to suitably pay a fee at the time of using a service in a blockchain network.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-114942, filed Jul. 18, 2024, which is hereby incorporated by reference herein in its entirety.

What is claimed is:

1. A non-transitory computer-readable storage medium storing a computer program that causes a computer of an information processing apparatus that executes a smart contract to function to:
in a blockchain network, receive a transaction related to a token that includes usage information of a service;
execute processing requested by the received transaction;
determine whether to add a block to a blockchain according to the executed processing;
in a case of adding the block, set a first wallet, which is owned by the information processing apparatus, or a second wallet, which is owned by an issuer of the transaction, as a payer of a fee for adding the block.

2. The storage medium according to claim 1, wherein
the computer program further causes the computer of the information processing apparatus to function to:
in a case where the processing requested by the received transaction is processing for issuing a token, set, as a fee for purchasing the token, a total amount, which includes a total fee, which is based on a fee and the number of block additions for notifying the usage information of the service when the service is used, and a fee for using the service, and further set a payee of the total fee to the first wallet, and set a payee of the fee for using the service to the second wallet, which is owned by the issuer of the transaction.

3. The storage medium according to claim 2, wherein
the computer program further causes the computer of the information processing apparatus to function to:
in a case where the processing requested by the received transaction is the processing for issuing a token, set, as a payer of a fee for adding a block, which accompanies the issuance processing, the second wallet, which is owned by the issuer of the transaction.

4. The storage medium according to claim 3, wherein
the computer program further causes the computer of the information processing apparatus to function to:
in a case where the processing requested by the received transaction is processing for purchasing a token, transmit the total fee to the first wallet and the fee for using the service to the second wallet, which is owned by the issuer of the transaction that requested the issuance processing, from a wallet of a purchaser.

5. The storage medium according to claim 4, wherein
the computer program further causes the computer of the information processing apparatus to function to:
in a case where the processing requested by the received transaction is the processing for purchasing a token, set, as the payer of the fee for adding the block, the second wallet, which is owned by the issuer of the transaction.

6. The storage medium according to claim 1, wherein
the computer program further causes the computer of the information processing apparatus to function to:
in a case where the processing requested by the received transaction is processing for notifying the usage information of the service, set, as the payer of the fee for adding the block, the first wallet, which is owned by the information processing apparatus.

7. The storage medium according to claim 6, wherein
the computer program further causes the computer of the information processing apparatus to function to:
in a case where the processing requested by the received transaction is processing for terminating usage of the service, set, as the payer of the fee for adding the block, the first wallet, which is owned by the information processing apparatus.

8. The storage medium according to claim 7, wherein
the computer program further causes the computer of the information processing apparatus to function to:
in a case where the processing requested by the received transaction is processing for monitoring service information, determine, not to add the block.

9. The storage medium according to claim 6, wherein
the first wallet is specified when the smart contract is arranged in the blockchain.

10. The storage medium according to claim 6, wherein
the service is a service provided by a printing apparatus.

11. The storage medium according to claim 10, wherein
the token is associated with the number of sheets that can be printed in the printing apparatus.

12. The storage medium according to claim 7, wherein
the token is a non-fungible token.

13. An information processing apparatus that executes a smart contract, the information processing apparatus comprising:
one or more memory devices that store a set of instructions; and
one or more processors that execute the set of instructions to:
in a blockchain network, receive a transaction related to a token that includes usage information of a service;
execute processing requested by the received transaction;
determine whether to add a block to a blockchain according to the executed processing;
in a case of adding the block, set a first wallet, which is owned by the information processing apparatus, or a second wallet, which is owned by an issuer of the transaction, as a payer of a fee for adding the block.

14. A method of controlling an information processing apparatus that executes a smart contract, the method comprising:
in a blockchain network, receiving a transaction related to a token that includes usage information of a service;
executing processing requested by the received transaction;
determining whether to add a block to a blockchain according to the executed processing;
in a case of adding the block, setting a first wallet, which is owned by the information processing apparatus, or a second wallet, which is owned by an issuer of the transaction, as a payer of a fee for adding the block.
